(19) United States
(12) Patent Application Publication
(10) Pub. No.: US 2026/0066605 A1
(43) Pub. Date: Mar. 5, 2026

(54) MULTIPLE RAMAN PUMP FBGS IN SINGLE FIBER

(71) Applicant: II-VI Delaware, Inc., Wilmington, DE (US)

(72) Inventor: Nadhum Kadhum Zayer, Newton Abbot (GB)

(21) Appl. No.: 18/823,304

(22) Filed: Sep. 3, 2024

(51) Int. Cl. H01S 3/067; H01S 3/30

(52) U.S. Cl. CPC H01S 3/0675; H01S 3/06754; H01S 3/302

(57) ABSTRACT

Disclosed herein are fiber-based Raman amplifier systems and methods of producing a broadband pump light utilizing a fiber Bragg grating (FBG) including a plurality of gratings. In disclosed systems and methods, the plurality of gratings each include a center wavelength (λ_{C}) corresponding, respectively, to a wavelength of an output from a laser, wherein the center wavelength (λ_{C}) of at least two gratings of the plurality of gratings are different from each other. Further disclosed are systems and methods using a pump source, where the pump source includes a plurality of the lasers optically connected, respectively, to a plurality of the FBGs, where at least two of the FBGs have a same FBG design with a plurality of the gratings.

### BACKGROUND

Unless otherwise indicated herein, the materials described herein are not prior art to the claims in the present application and are not admitted as prior art by inclusion in this section.

Raman amplification is an amplification technique, used to transmit an optical information signal over long distances, by using Raman scattering, an inelastic “scattering” process where photons interact with the vibrational modes of their medium of transfer (i.e., photons interacting with fiber optic material) allowing for a shift of their energy, for amplifying the optical information signal. An optical pump source (e.g., a laser) can provide photons, at a certain wavelength, that is different from that of the optical signal, allowing the signal to be amplified via the transfer of energy from the Raman scattering process. This pump amplification process is referred to as Stimulated Raman Scattering (SRS), and frequently uses a relatively higher power pump source (as compared to the optical information signal) or pump laser introduced into an optical fiber along with the optical information signal.

Raman amplification systems typically include a transmitter for generating the optical information signal, a pump source for generating the pump energy, and an optical fiber medium in which to amplify the optical information signal using the pump energy.

### BRIEF SUMMARY

This summary is provided to introduce a selection of concepts in a simplified form that are further described below in the detailed description. This summary is not intended to identify key features or essential characteristics of the claimed subject matter, nor is it intended to be used as an aid in determining the scope of the claimed subject matter.

Disclosed herein are fiber-based Raman amplifier systems. In one aspect of the disclosure, the fiber-based Raman amplifier systems include a fiber Bragg grating (FBG) including a plurality of gratings, each grating including a center wavelength (λ_{C}) corresponding, respectively, to a wavelength of an output from a laser, where the center wavelength (λ_{C}) of at least two gratings of the plurality of gratings are different from each other. In one aspect of the disclosure disclosed fiber-based Raman amplifier systems may include a plurality of gratings having a center wavelength (λ_{C}) between 1400 and 1500 nm.

The disclosed fiber-based Raman amplifier systems may also further include a pump source, where the pump source includes a plurality of the lasers optically connected, respectively, to a plurality of the FBGs. Disclosed fiber-based Raman amplifier systems may also include a number of lasers where the number of lasers and number of FBGs is equivalent. In another aspect of the disclosure, disclosed fiber-based Raman amplifier systems may further include at least two of the plurality of FBGs having different FBG designs from each other. In yet another aspect of the disclosure, the plurality of FBGs have at least two FBGs having a same FBG design as each other. Additionally, in another aspect, each of the plurality of lasers has an optical output different from the other lasers of the plurality of lasers, and the optical output of each of the lasers overlaps with at least one of the center wavelengths (λ_{C}) of the FBGs.

In one aspect of the disclosure, disclosed fiber-based Raman amplifier systems may include a wavelength offset between the plurality of center wavelengths (λ_{C}), the wavelength offset being greater than or equal to about 15 nanometers (nm). And in another aspect of the disclosure, disclosed FBGs may include from two to five gratings. And, in another aspect of the disclosure, a reflectivity of each of the plurality of gratings is from about 1.0% to about 5.0% reflective at its respective center wavelength (λ_{C}).

Disclosed herein are fiber-based Raman amplifier systems, where each of the plurality of gratings further include a plurality of alternating segments including high refractive index segments and low refractive index segments, the high refractive index segments having a high refractive index (n₁) higher than a low refractive index (n₂) of the low refractive index segments, a grating length, a grating pitch (Λ), and an effective refractive index n₀, defined as: a difference (change in refractive index (Δn) 308) between the (n₁) of the high refractive index segments and the (n₂) of the low refractive index segments divided by two, where the center wavelength (λ_{C}) of each of the plurality of gratings is equal to 2n₀(Λ).

In one aspect of the disclosure, a difference between n₁ and n₂ is on the order of 10⁻⁵. In another aspect of the disclosure, each of the center wavelength (λ_{C}) for each of the plurality of gratings are all within a Raman band. In yet another aspect of the disclosure, a plurality of center wavelengths (λ_{C}) are within a range of Raman amplification for a signal light having a wavelength from about 1380 nm to about 1510 nm. In one aspect of the disclosure, disclosed fiber-based Raman amplifier systems may include a plurality of gratings within the FBG having a positive separation length. And, in an additional aspect of the disclosure, the FBG has a grating region length of less or equal to about 10 mm.

In one aspect of the disclosure, disclosed fiber-based Raman amplifier systems may include a plurality of gratings within the FBG having a negative separation length. In an additional aspect of the disclosure, the FBG has a grating region length of less or equal to about 2.5 mm. In yet another aspect of the disclosure, the plurality of gratings within the FBG each have a grating length of less than about 0.5 mm. And, in another aspect of the disclosure, at least one of the plurality of pump sources has an output wavelength which overlaps with at least one of the center wavelengths (λ_{C}).

Disclosed herein are methods of generating a broadband pump light for Raman amplification of a signal light. In one aspect of the disclosure, the methods may include optically connecting a plurality of FBGs to a plurality of lasers, respectively, where each of the plurality of lasers has an optical output different from other lasers of the plurality of lasers and each of the plurality of FBGs includes a plurality of gratings, each grating having a center wavelength (λ_{C}) overlapping, respectively, to a wavelength of the optical output from at least one of the plurality of lasers, and the center wavelength (λ_{C}) of the plurality of gratings are different from each other, and at least two of the plurality of FBG have a same FBG design. In another aspect of the disclosure the methods may further include emitting the optical output of each of the plurality of lasers through the respective FBG to generate a plurality of pump lights and optically combining the plurality of pump lights to form a broadband pump light. In another aspect of the disclosure, the disclosed methods may include optically combining the broadband pump light signal with a signal light into an optical fiber.

### BRIEF DESCRIPTION OF THE SEVERAL VIEWS OF THE DRAWINGS

FIG. 1 shows a schematic of a Raman amplifier system in accordance with disclosed embodiments;

FIG. 2 shows a cross-section of an example optical fiber having an FBG in accordance with disclosed embodiments;

FIG. 3 shows a graph of refractive index along in accordance with disclosed embodiments;

FIG. 4 illustrates a schematic view of an FBG in accordance with disclosed embodiments;

FIG. 5 shows a schematic of a Raman amplifier system in accordance with disclosed embodiments;

FIG. 6A shows a cross-section of an example FBG in accordance with disclosed embodiments; and

FIG. 6B shows a cross-section of an example FBG in accordance with disclosed embodiments.

### DETAILED DESCRIPTION

It is to be understood that the figures and descriptions of the present invention may have been simplified to illustrate elements that are relevant for a clear understanding of the present embodiments, while eliminating, for purposes of clarity, other elements found in an optical device, Raman amplifier, FBG, or related systems. Those of ordinary skill in the art will recognize, upon reading this disclosure, that other elements may be desirable and/or required in order to implement the present embodiments. However, because such elements would be understood from reading this disclosure, and because they are not required to facilitate a better understanding of the present embodiments, a discussion of such elements is not provided herein. It is also to be understood that the drawings included herewith only provide diagrammatic representations of the presently preferred structures of the present invention and that structures falling within the scope of the present embodiments may include structures different than those shown in the drawings. Reference will now be made to the drawings wherein like structures are provided with like reference designations.

In telecommunication applications, it can be beneficial to provide optical amplification across one or more optical communication bands (or a subset thereof), which are generally within the near infrared portion of the electromagnetic spectrum. For example, the International Standards Union divides the optical telecommunication spectrum into the following communication bands, the O-band, the E-band, the S-band, the C-band, and the L-band. For purposes of this application the following band ranges can be assumed: O-band range of 238.8 to 220.6 THz, 1260 to 1360 nm; E-band range of 220.6 to 205.5 THz, 1360 to 1460 nm; S-band range of 202.0 to 197.0 THz to 191 THz, 1484 to 1522 nm (est.); C-band range of 196.5 to 191.5 THz, 1525 to 1565 nm; C++ band range of 197 THz to 191 THz, 1524 nm to 1572 nm; L-band range of 191.0 to 186.0 THz, 1570 to 1612 nm; L++ band range of 190.5 THz to 184.35 THz, 1573 nm to 1626 nm.

However, because typical pump sources cannot cover an entire communication band (or even a subset thereof) with sufficient optical power, more than one pump source having different wavelengths may be used to provide sufficient pumping bandwidth to obtain the desired amplification across a desired band. Further, when using pump sources, it can also be advantageous to control the output wavelength of the pump or pumps. For example, in order to provide amplification of optical signals in the C-band, a combined pumping wavelength of about 1400 nm to about 1500 nm may be desired. For a pump source that includes a laser, e.g., a semiconductor laser, such control may be accomplished through the use of external reflectors that reflect certain wavelengths back into the laser cavity to “lock” the pump laser to a specific wavelength. In disclosed examples, such a reflector is accomplished through one or more fiber Bragg gratings (FBGs), which are distributed Bragg reflectors, or gratings, within an optical fiber core. The narrow bandwidth of the FBG results in forcing the laser to lase with a selective longitudinal mode defined by the FBG bandwidth, thus locking the pump light to specific wavelength target based on a center wavelength (λ_{C}) of the grating.

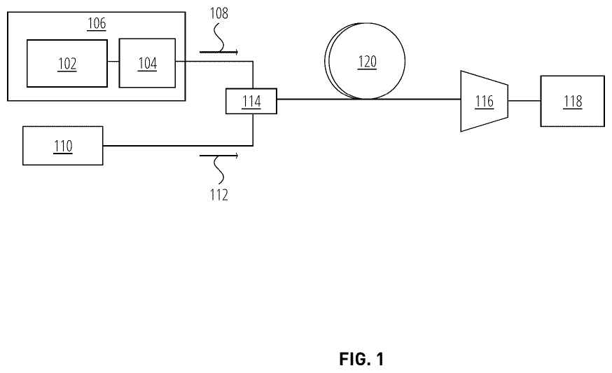

FIG. 1 is a schematic representation of an example Raman amplifier 100 system. The Raman amplifier 100 includes a signal light source 110 for providing a signal light 112 that would typically contain optical information. The signal light 112 is optically connected to an optical combiner 114, in which the signal light 112 is optically combined with pump light 108 for providing the pump or amplification energy. The optical combiner 114 is optically connected to an optical fiber 120 which functions as the Raman amplification medium. The combined signal (signal light 112 plus pump light 108) is optically sent into the optical fiber 120 in which Raman amplification occurs via Raman scattering (the interaction of the fiber with the high-energy photons of the pump light 108) resulting in a transfer of energy to the signal light 112. The optical fiber 120 may be comprised of silica glass, or silica doped with Germanium, Phosphorus, Boron, Alumina, or another material with high photosensitivity and low attenuation. Although not required, the Raman amplifier 100 may also include a filter 116 optically connected to the optical fiber 120, to provide additional signal filtering, e.g., to filter out any unused pump light 108. After being filtered, the amplified signal light 112 is received and processed by the receiver 118, which is optically connected to the optical fiber 120 and/or filter 116. It should be understood that any optical connection can optionally include interceding waveguides, junctions, switches, splitters, or the like and does not require “direct” optical connection unless specifically stated.

The pump source 106 includes a laser 102 as well as a fiber Bragg grating, FBG 104. The FBG 104 “locks” the emitted wavelength of the laser to a narrow bandwidth and provides the optical feedback required for the laser 102. While Raman amplifier 100 shows the pump and signal light 112 traveling in the same direction through the optical fiber 120, i.e., in a “forward” pumped configuration, additionally or alternatively, a backward pump may be provided after the optical fiber 120, which sends pump light in the opposite direction as the signal light 112 through the optical fiber 120.

The lasers disclosed herein, i.e., laser 102, may be implemented using varying implementation and wavelengths, including fiber lasers, diode lasers, discharge lamps/lamp-pumped lasers, laser diodes/diode-pumped lasers, or other types of lasers such as titanium-sapphire lasers, gas lasers, etc. The filter 116 may be implemented using a wavelength division multiplexer, a bandpass filter, notch filter, etc. The receiver 118 may be implemented using a photodiode receiver, transimpedance receiver, etc.

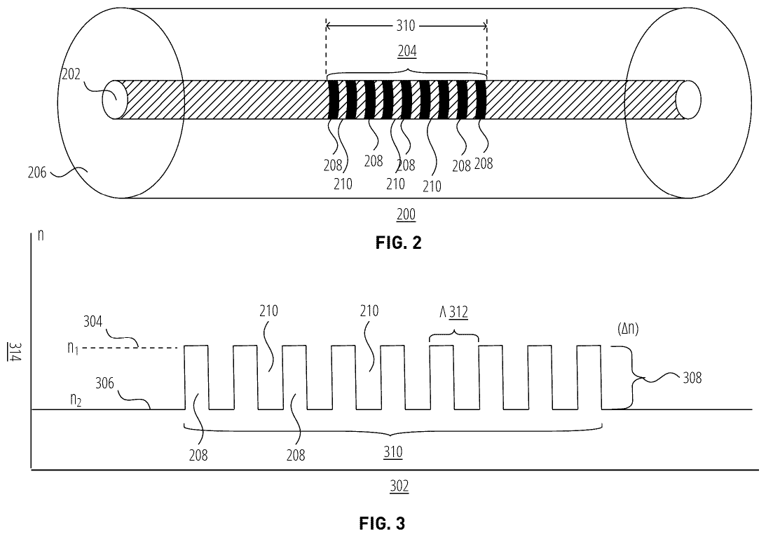

As discussed above, an FBG is a distributed Bragg reflector within an optical fiber that is made of segments having alternating high/low (relatively) refractive indices that, when combined, reflect specific wavelengths of light while transmitting others through the FBG. FIG. 2 shows a cross-section of an FBG 200, the FBG 200 includes a core 202 with a grating 204 surrounded by a cladding 206. The core 202 transmits an optical input based on total internal reflection and may be comprised of glass materials, most frequently silica. The optical fiber additionally contains cladding 206, used to confine the light within the core 202, and an exterior coating (not shown) used as a protective layer. The grating 204 within the optical fiber 120 is depicted with a non-specific distance apart for clarity of illustration. The grating 204, includes alternating segments of relatively high refractive index segments 208 and relatively low refractive index segments 210, although not all of such segments are labeled and the number and dimensions of the segments are merely schematically represented and not to scale. The grating 204 may be inscribed into the core of an optical fiber using an etching technique such as with UV laser. For example, a UV laser may impart structural changes within a doped (germanium or other suitable material) optical fiber core at the desired location of the plurality of segments causing the refractive index at the exposure to increase, while areas where no exposure is present will remain at a relatively lower index of refraction. Such segments may be written serially or at the same time using interference lithography.

FIG. 3 is a graph of the relative refractive index of the grating 204 of FIG. 2. While certain properties and terms will be discussed with respect to FIG. 3, they are equally applicable to the FBG 200 of FIG. 2. FIG. 3 shows the relative value of refractive index (n) along the vertical axis 314 versus the longitudinal distance along the core 202 on horizontal axis 302. The values of the graph are shown as discrete and non-continuous, although there may be small gradients in actual materials. The relatively larger value being a high refractive index segment 208 with a higher refractive index (n₁) 304 and the lower value being a low refractive index segment 210 having a lower refractive index (n₂) 306. The difference between the higher refractive index (n₁) 304 and the lower refractive index (n₂) 306 equals the change in refractive index (Δn) 308. The change in refractive index (Δn) 308 divided by two provides an estimate for the effective refractive index n₀ of the core of the fiber at the grating 204, i.e., within the grating length 310. The distance between adjacent segments having the same refractive index is the grating pitch (Λ). As shown, the grating pitch (Λ) 312 is the distance between the beginnings of two adjacent high refractive index segment 208. And the length of the grating along the longitudinal axis of the optical fiber is the grating length 310. The reflected wavelength of the grating 204 is determined by λc=2n₀(Λ), where λc is the center wavelength of the reflected light, n₀ is the effective refractive index of the grating (e.g., (higher refractive index (n₁) 304 minus lower refractive index (n₂) 306)/2) and Λ is the grating pitch (Λ) 312. The reflectivity (percentage of light reflected back toward the source) of the grating 204 will also increase with increasing number of segments (208/210). In one example, disclosed gratings 204 have a reflectivity from about 1.0% to about 5.0% and have a grating length 310 of less than about 0.5 millimeters (mm).

In instances where multiple pump sources 106 are used to cover the desired pumping band, a different FBG may be used for each laser 102. For example, a first FBG having a first grating can be optically coupled to a first laser 102 to generate a first pump light 108 and a second FBG having a second grating (different than the first grating) can be optically coupled to the second laser 102 to generate a second pump light 108 (different than the first pump light 108). However, such examples then require different FBGs for each laser. In each of the examples discussed further in this disclosure, and as will be discussed further below, disclosed example FBGs may also include multiple different gratings within a single fiber to provide for using the same FBG design with multiple lasers to generate different pump light 108 wavelengths, respectively, with different lasers 102. The ability to use the same FBG design for a plurality of different pump sources provides for improved efficiency and cost effectiveness.

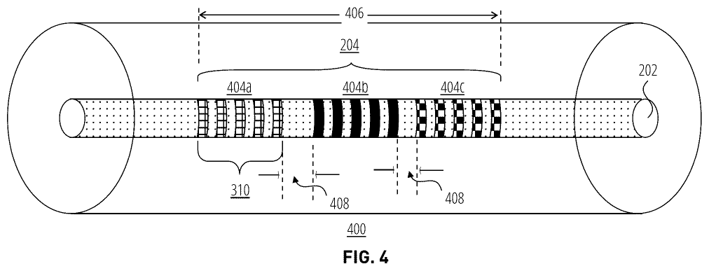

FIG. 4 shows an FBG 400. The FBG 400 is substantially similar to FBG 200 discussed above, including similar features that will not be discussed again. However, the FBG 400 of FIG. 4 includes a plurality of gratings 204, shown as grating 404a, grating 404b, and grating 404c. While three gratings 204 are shown for illustrations purposes, FBG 400 may include two or more gratings 204, for example, two, three, four, five, six, or seven or more gratings 204 within FBG 400. The distance between the gratings 204 are not shown to scale. Each of the gratings 404a, 404b, 404c has a length (along the longitudinal direction of the FBG 400) from the beginning of its respective first segment to the end of its respective last segment, defining its grating length 310. Additionally, each of the gratings 404a, 404b, 404c are spaced a distance apart from one another, defining a separation length 408, which is the distance from the end of a preceding grating's last segment to the beginning of the first segment of the next successive grating 204. Each separation length 408 may, as shown, be positive, i.e., there is space between adjacent gratings 204, or alternatively, one or more separation lengths 408 may be negative, i.e., overlapping (discussed further below). The length of the fiber which contains the plurality gratings 204 is defined as the region length 406.

In one example, each grating of a plurality of adjacent gratings 204 within the FBG 400 has a grating length 310 of between about 0.5 mm and about 3.0 mm, for example, about 0.5 mm and a region length 406 of the plurality of gratings 204 of less than or equal to about 10 mm. In one embodiment, the separation lengths 408 of the gratings 204 may be between about 1.0 mm and about 10 mm. In one example the separation lengths 408 between adjacent gratings 204 may be different. For example, the separation length 408 between a first grating 404a and second grating 404b may be different than a separation length 408 between a second grating 404b and a third grating 404c.

The plurality of gratings 204 within the FBG 400 may each have different center wavelengths (λ_{C}), or alternatively, two or more of the plurality of gratings 204 may each have different center wavelengths (λ_{C}). As discussed above, the center wavelengths (λ_{C}) of each of the plurality of gratings 204 may be varied by varying the effective refractive index n₀ or the grating pitch (Λ) among the gratings. Further the reflectivity of the respective gratings may also be varied by varying the number of segments of the respective gratings 204. For FBG 400 or other FBGs having multiple gratings therein, the plurality of gratings may be written into the fiber core 202, for example serial, with multiple exposures or, for example, fewer or single interference exposures writing all of the segments at once.

With an FBG 400 having a plurality of gratings 204 with different center wavelengths (λ_{C}), the same design FBG 400 can be used with a plurality of different pump sources 106 without needing to manufacture or stock different FBGs for each different laser 102 used within a pump source 106. This also reduces design and manufacturing time for the FBG used with the plurality of lasers 102 by being able to utilize a single product run/setup to manufacture all of the required FBGs for the plurality of different lasers.

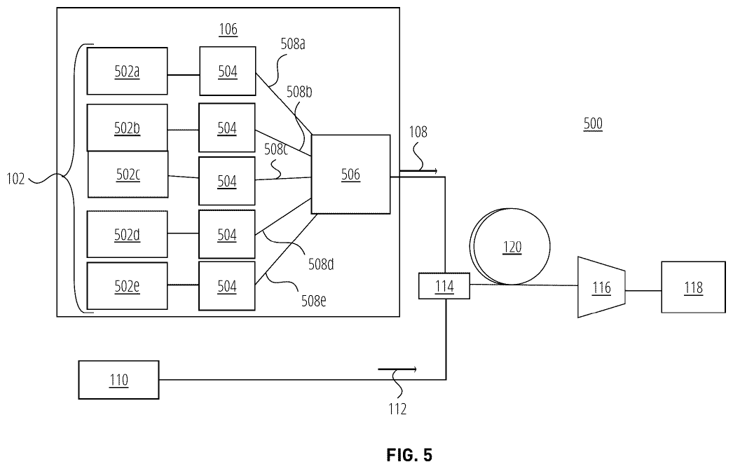

FIG. 5 is a schematic representation of an example Raman amplifier 500 system. The Raman amplifier 500 system shown in FIG. 5 is similar to that of the Raman amplifier 100 and the discussion with respect to FIG. 1 is equally applicable to that of FIG. 5. While the pump source 106 of FIG. 1 is described with respect to single laser 102, the pump source 106 of FIG. 5 includes a plurality of lasers 102, depicted as lasers 502a, 502b, 502c, 502d, and 502e. The plurality of lasers 502a, 502b, 502c, 502d, and 502e include at least two lasers 102 that have different wavelength output from each other, and thus require different feedback from the external reflector to lock the particular applicable wavelength. Each of the plurality of lasers 102 is optically connected to a respective FBG 504. The FBG 504 may be similar to the FBG 400 of FIG. 4 in that the FBG 504 includes a plurality of gratings 204 different from each other therein, in which each of the plurality of gratings 204 within FBG 504 corresponds to respective one of the lasers 502a, 502b, 502c, 502d, and 502e. In the example shown in FIG. 5, while all lasers 102 are not required to be different, assuming each of the lasers 502a, 502b, 502c, 502d, and 502e provide different wavelengths from each other, then FBG 504 may include five different gratings 204 therein. While the example of FIG. 4 shows three different gratings 404a, 404b, 404c, in the example shown in the FIG. 5, additional gratings can be included in FBG 504. Further, while each of lasers 502a, 502b, 502c, 502d, and 502e provide different wavelengths, the same design, i.e., the same pattern of the plurality of gratings 204, may be used for each FBG 504 optically connected, respectively, to each of lasers 502a, 502b, 502c, 502d, and 502e. In this way, a single FBG 504 design (having the same set of plurality of gratings 204 therein) may be used for the plurality of lasers 102 having different wavelength outputs.

In one example configuration, each of the plurality of gratings 204 within FBG 504 has a center wavelength (λ_{C}) that is a minimum distance apart (in wavelength) from one another, such that each laser 502a, 502b, 502c, 502d, and 502e substantially only interacts with the grating 204 within FBG 504 having a center wavelength (λ_{C}) of reflectivity associated with the respective laser 502a, 502b, 502c, 502d, and 502e output. That is, a subset, e.g., fewer than all, or one, of the plurality of gratings 204 within the FBG 504 will have substantial (>3%) reflectivity with respect to the corresponding wavelength(s) of the optically connected laser 102, while the other gratings 204 within the optically connected FBG 504 will have a reflectivity such that they are effectively optically transparent to the optically connected laser 102. In one example, an FBG being optically transparent at a wavelength is an FBG having a negligible reflectivity for that wavelength such that no side loops occur, for example having a less than a 20 dB drop in signal for that particular wavelength. In another example, for an FBG to be optically transparent, it will have a reflectivity of <0.1%, or in other examples, <0.5%, or <1%, although having lower reflectivity is preferred. In one example the minimum distance between center wavelengths (λ_{C}) of gratings within the FBG 504 is 15 nanometers (nm), that is, each grating of the plurality of gratings 204 within the FBG 504 should have a center wavelength (λ_{C}) of reflectivity greater than or equal 15 nm from the center wavelength (λ_{C}) of other gratings 204 within the FBG 504 having the next closest center wavelength (λ_{C}).

Each laser 502a, 502b, 502c, 502d, and 502e, with a respective FBG 504, thus produces different pump lights 508a, 508b, 508c, 508d, 508e, which may be combined through an optical combiner 506 into pump light 108 to provide a more broadband pump light 108 as compared to a pump light generated by only a single wavelength laser. In this way, a pump light 108 can be generated to more broadly Raman amplify one or more communication or other bands of signal light 112.

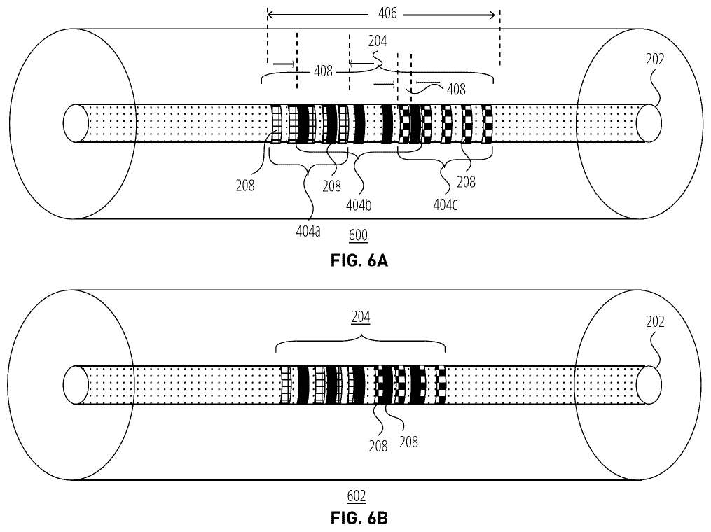

FIG. 6A illustrates an FBG 600 similar to that described with respect to FBG 400 of FIG. 4. Thus, the discussion with respect to FBG 400 is equally applicable to FBG 600. In addition, FBG 600 could also be used in place of FBG 504, discussed above with respect to FIG. 5. While FBG 400 includes positive separation lengths 408, i.e., the plurality of gratings 204 of FIG. 4 do not overlap, the plurality of gratings 204 (gratings 404a, 404b, 404c) of FIG. 6A do overlap and thus have negative separation lengths 408. In this way, the same number of gratings 204 may be included within FBG 600 while decreasing the region length 406 for FBG 600. In one example, five gratings 204 may be included within FBG 600 while maintaining a region length 406 of less than or equal to about 2.5 mm while maintaining a minimum distance between center wavelengths (λ_{C}) of the plurality of gratings 204 of greater than or equal to 15 nm. In the example FBG 600 shown in FIG. 6A, the individual high refractive index segments 208 of each of the respective plurality of gratings 204 do not overlap with each other. That is, while the start and stop of respective gratings 404a, 404b, 404c overlap, the high refractive index segments 208 do not. As discussed before, the individual gratings 404a, 404b, 404c may each vary in the center wavelength (λ_{C}) through variation of their constructions.

FIG. 6B illustrates an FBG 602 similar to that as FBG 600 of FIG. 6A, and thus certain reference numerals are omitted for clarity. In contrast to FBG 600, FBG 602 includes segments from different gratings 404a, 404b, 404c that do overlap with each other. For example, high refractive index segments 208 (of FIG. 6B). It should be noted that the overlap of multiple high refractive index segments 208 has been exaggerated in FIG. 6B for illustration purposes only and in certain examples there be only two overlapping high refractive index segments 208. Overlapping segments may cause some degradation or change in the effective refractive index n₀ of the respective gratings 204, however such degradation can be a trade-off with respect to overall region length 406 and may only present minimal impact depending on the reflectivity of the respective grating 204.

As discussed above, it can be beneficial to utilize FBGs having multiple different gratings therein that optically overlap with multiple pump lasers to create a broadband pump light. Further disclosed are methods of generating a broadband pump light for Raman amplification of a signal light, including optically connecting a plurality of FBGs to a plurality of lasers, respectively, where at least two of the plurality of lasers has an optical output different from the other of the plurality of lasers and each of the plurality of FBGs includes a plurality of gratings, each grating having a center wavelength (λ_{C}) overlapping, respectively, to a wavelength of the optical output from at least one of the plurality of lasers, and the center wavelength (λ_{C}) of the plurality of gratings are different from each other, and at least two of the plurality of FBG have a same FBG design. The method may further include emitting the optical output of each of the plurality of lasers through the respective FBG to generate a plurality of different pump lights and optically combining the plurality of pump lights to form the broadband pump light. As discussed above, such broadband pump light may be optically combined with a signal light for Raman amplification within an optical fiber media.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A fiber-based Raman amplifier system, comprising:
a fiber Bragg grating (FBG) including a plurality of gratings, each grating including:
a center wavelength (λ_{C}) corresponding, respectively, to a wavelength of an output from a laser, wherein the center wavelength (λ_{C}) of at least two gratings of the plurality of gratings are different from each other.

2. The fiber-based Raman amplifier system of claim 1, wherein the plurality of gratings have a center wavelength (λ_{C}) between 1400 and 1500 nm.

3. The fiber-based Raman amplifier system of claim 1, further comprising:
a pump source, wherein the pump source includes a plurality of the lasers optically connected, respectively, to a plurality of the FBGs.

4. The fiber-based Raman amplifier system of claim 3, wherein the number of lasers and FBGs is equivalent.

5. The fiber-based Raman amplifier system of claim 3, wherein the plurality of FBGs have at least two FBGs having a same FBG design.

6. The fiber-based Raman amplifier system of claim 5, wherein the plurality of FBGs have at least two of FBGs having different FBG designs from each other.

7. The fiber-based Raman amplifier system of claim 5, wherein each of the plurality of lasers has an optical output different from the other lasers of the plurality of lasers, and,
the optical output of each of the lasers overlaps with at least one of the center wavelengths (λ_{C}).

8. The fiber-based Raman amplifier system of claim 1, further comprising a wavelength offset between the plurality of center wavelengths (λ_{C}), the wavelength offset being greater than or equal to about 15 nanometers (nm).

9. The fiber-based Raman amplifier system of claim 1, wherein the FBG comprises from two to five gratings.

10. The fiber-based Raman amplifier system of claim 1, wherein a reflectivity of each of the plurality of gratings is from about 1.0% to about 5.0% reflective at its respective center wavelength (λ_{C}).

11. The fiber-based Raman amplifier system of claim 1, wherein each of the plurality of gratings further comprises:
a plurality of alternating segments including high refractive index segments and low refractive index segments, the high refractive index segments having a high refractive index (n₁) higher than a low refractive index (n₂) of the low refractive index segments;
a grating length;
a grating pitch (Λ); and
an effective refractive index n₀, defined as:
a difference (change in refractive index (Δn)) between the (n₁) of the high refractive index segments and the (n₂) of the low refractive index segments divided by two;
wherein:
the center wavelength (λ_{C}) of each of the plurality of gratings is equal to 2n₀(Λ).

12. The fiber-based Raman amplifier system of claim 11, wherein the difference between n₁ and n₂ is about 0.0001.

13. The fiber-based Raman amplifier system of claim 1, wherein each of the center wavelength (λ_{C}) for each of the plurality of gratings are all within a Raman band, between 1400 and 1500 nm.

14. The fiber-based Raman amplifier system of claim 1, wherein the plurality of center wavelengths (λ_{C}) are within a range of Raman amplification for a signal light having a wavelength from about 1380 nm to about 1510 nm.

15. The fiber-based Raman amplifier system of claim 1, wherein the plurality of gratings within the FBG have a positive separation length.

16. The fiber-based Raman amplifier system of claim 15, wherein the FBG has a grating region length of less or equal to about 10 mm.

17. The fiber-based Raman amplifier system of claim 1, wherein the plurality of gratings within the FBG have a negative separation length.

18. The fiber-based Raman amplifier system of claim 17, wherein the FBG has a grating region length of less or equal to about 2.5 mm.

19. The fiber-based Raman amplifier system of claim 1, wherein the plurality of gratings within the FBG each have a grating length of less than about 0.5 mm.

20. The fiber-based Raman amplifier system of claim 19, wherein at least one of the plurality of pump sources has an output wavelength which overlaps with at least one of the center wavelengths (λ_{C}).

21. A method of generating a broadband pump light for Raman amplification of a signal light, the method comprising:
optically connecting a plurality of FBGs to a plurality of lasers, respectively, wherein each of the plurality of lasers has an optical output different from the other lasers of the plurality of lasers and each of the plurality of FBGs includes a plurality of gratings, each grating having a center wavelength (λ_{C}) overlapping, respectively, to a wavelength of the optical output from at least one of the plurality of lasers, and the center wavelength (λ_{C}) of the plurality of gratings are different from each other, and at least two of the plurality of FBG have a same FBG design;
emitting the optical output of each of the plurality of lasers through the respective FBG to generate a plurality of pump lights;
optically combining the plurality of pump lights to form the broadband pump light.

22. The method of claim 21, further comprising optically combining the broadband pump light signal with the signal light into an optical fiber.
